(19) United States
(12) Patent Application Publication
(10) Pub. No.: US 2009/0049302 A1
(43) Pub. Date: Feb. 19, 2009

(54) System And Method For Processing Conent For Later Insertion Of Digital Watermark And Other Data

(75) Inventors: Jian Zhao, Valencia, CA (US); Michael Zink, Los Angeles, CA (US); Alan Hamersley, Newbury Park, CA (US)

Correspondence Address: Joseph J. Laks;Thomson Licensing LLC, 2 Independence Way, Patent Operations, PO Box 5312, PRINCETON, NJ, 08543, US

(73) Assignee: THOMASON LICENSING, BOULOGNE-BILLANCOURT (FR)

(21) Appl. No.: 12/225,129

(22) PCT Filed: Mar. 17, 2006
(86) PCT No.: PCT/US2006/009992

§ 371 Date: Sep. 15, 2008

(51) Int. Cl. H04L 9/06

(52) U.S. Cl. 713/176

(57) ABSTRACT

A method and system for processing content are described including generating a dummy value, inserting the dummy value into encoded content, selecting a position in the encoded content where the dummy value in the encoded content is to be replaced by a real value, generating the real value and replacing the dummy value with the real value in the encoded content.

### FIELD OF THE INVENTION

The present invention relates to digital watermarks and other data and in particular to a method and apparatus for processing content for later insertion of digital watermarks and other data.

### BACKGROUND OF THE INVENTION

In one prior art approach, additional data are inserted by searching for redundant data in the encoded content and then replacing the redundant data with the real additional data. The prior art describes various ways to locate such redundant data in motion pictures experts group (MPEG) transport streams. Such redundant data are often added by commercial MPEG encoders and/or multiplexers in MPEG transport streams to control the bit rate.

In another prior art approach, the additional data are inserted by splicing two encoded units of content. The prior art describes a method of splicing two MPEG transport streams without re-multiplexing.

### SUMMARY OF THE INVENTION

The present invention creates dummy data (or padding data) as “place holders” during content encoding and authoring. At a later stage, these dummy data are replaced by real additional data (watermarks and other data). The real additional data is inserted into the encoded/multiplexed content without re-encoding or re-multiplexing. Thus, the additional data are inserted into the encoded and multiplexed content with minimal further processing of the content and with minimal impact on the workflow. Content as used herein includes video, audio and any other multimedia content.

A method and system for processing content are described including generating dummy values, multiplexing the dummy values with a transport stream of the content, selecting at least one position in the content where a value in the content is to be replaced by an alternative value containing a watermark signal, generating at least one alternative value and inserting the at least one alternative value in the content.

### BRIEF DESCRIPTION OF THE DRAWINGS

The present invention is best understood from the following detailed description when read in conjunction with the accompanying drawings. The drawings include the following figures briefly described below where like-numbers on the figures represent similar elements:

FIG. 1 shows encoded content before watermarks and other data are multiplexed.

FIG. 2 shows encoded content with watermarks and other data inserted.

FIG. 3 shows the method of the present invention applied during content authoring and content replication.

FIG. 4 depicts the insertion of dummy Advanced Access Content System data during the content authoring phase and the subsequent substitution of Advanced Access Content System keys and files for the dummy files during the replication phase.

### DETAILED DESCRIPTION OF THE PREFERRED EMBODIMENTS

As described in PCT application “Watermarking Encoded Content” (PCT/05/43895, filed Dec. 5, 2005), the process to watermark an encoded content consists of three separate steps:
Location selection, which is the selection of the position where the value in the encoded content can be replaced by alternative values containing watermark signals.
Calculation of alternative values, which is the determination of the alternative values so that the alternative values have the same number of bits as the value the alternative values are to replace in the encoded content and such substitution will not cause perceptual changes to the content. Moreover, these alternative values contain watermark and other data signals.
Watermark embedding/insertion, which is the actual replacement/substitution of the value in the encoded content by one of the alternative values containing watermark signals.

The first two steps can be pre-processed before the playback of the content. As a result of the pre-processing, a set of watermark units (WUs) are produced. WUs contain all information for actually embedding/inserting a watermark and other data. Each WU may include the following fields:
P—the position of the watermark signal in the encoded content. This can be a global byte offset from a known position in the encoded content;
L—the number of bits occupied by the original value. The start position of the original value is specified by P.
V—the original value.
V1, V2, . . . Vn—the valid alternative values containing watermark signals of V. In other words, the replacement of V by any of these alternative values in the encoded content result in neither corruption of the content format nor perceptual artefacts. Each of these alternatives may contain a different watermark signal.

The watermark pre-processor takes an encoded content as the input and a watermark key, and outputs a sequence of watermark units. As disclosed in PCT/05/43895, filed Dec. 5, 2005, these watermark units are integrated into the final content as meta-data of the encoded content, as a separate channel multiplexed with the content, as steganographic data hidden in the syntax elements or in the content, or as a separate file stored in the physical media (optical disc, tape, hard driver, etc.) or transmitted over network (TCP/IP, satellite, etc.).

If WUs are multiplexed with the encoded content, the global position P in each WU in the final multiplexed content must be re-calculated and adjusted because of the insertion of WUs. In one example, assume WU1=(P1, 40, V1, V1a) and WU2=(P2, 40, V2, V2a) are two WUs where V1 and V2 are the original values, and V1a and V2a are the alternative values for each WU, respectively.

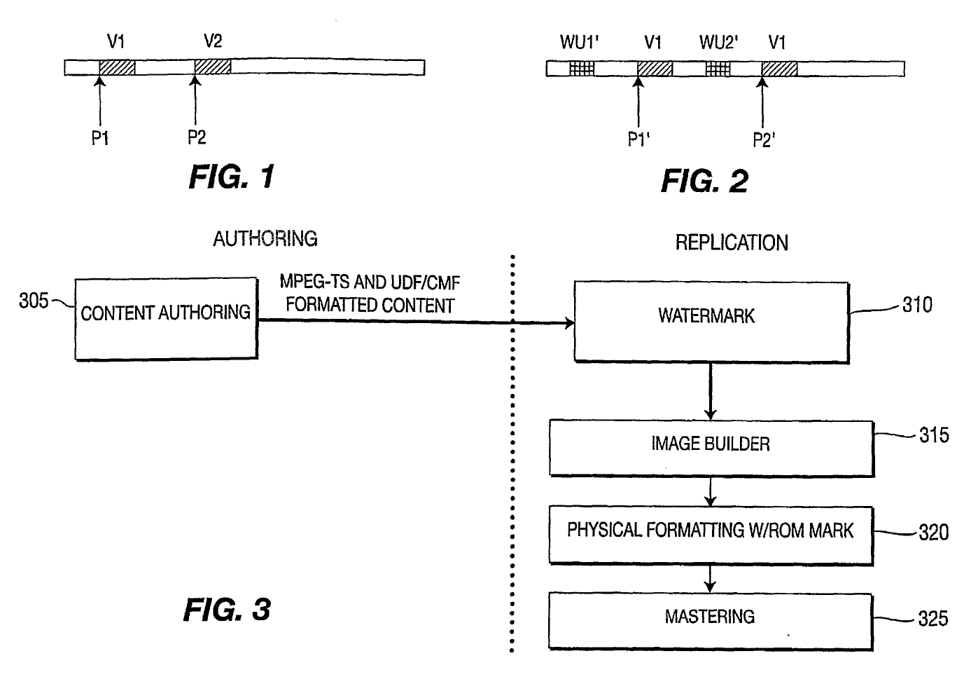

FIG. 1 shows the encoded content before these two WUs are multiplexed with encoded content. FIG. 2 shows the encoded content after the encoded content is multiplexed with the WUs. As shown in FIG. 2, the global positions P1 in WU1 and P2 in WU2 become P1′ and P2′ after the insertion of WU1′=(P1′, 40, V1, V1a) and WU2′=(P2′, 40 V2, V2a) in the encoded content.

To avoid such re-calculation and adjustment of global positions in WUs, the present invention adds “dummy” WUs in the encoded content before the watermark pre-processing phase (which produces real WUs) during one of the content preparation phases. The content preparation phases encode, author and multiplexing multiple components of the content. These “dummy” WUs are identical in size to the real WUs and are inserted in the appropriate places of the encoded content.

FIG. 3 shows the method of the present invention applied during content authoring and replication. Replication is the copying of the processed content (including watermark and/or film marks, which are both herein called watermarks) onto storage media for distribution through/to retail channels including theaters, broadcast media, retail sales/rental outlets etc. Storage media include, but are not limited to, physical media such as optical disks, compact discs (CDs), DVDs, VHS or other tapes. During the content authoring, which is performed by a Content Authoring module 305, the maximum number of dummy WUs are multiplexed with the MPEG-TS (transport stream). The MPEG-TS is further formatted to UDF/CMF files for replication. CMF (Cutting Master Format) is a standardized way of communicating and transferring data between DVD title authoring workstations and DVD glass master cutting systems. UDF (Universal Disk Format) is a specification enabling the file interchange among various platforms and is optimized for large contiguous files. The dummy WU values that are generated can be added to the UDF files, which are then formatted as CMF files or the dummy WU values can be added directly to the CMF files.

In the replication stage, the watermark pre-processor module 310 first parses the UDF/CMF formatted files and extracts the MPEG-TS. Then the watermark pre-processor 310 performs steps 1 and 2 as described above to select locations and calculate alternative values. After WUs are produced, the dummy WUs in MPEG-TS are located and replaced with the real WUs by the watermark pre-processor module 310. If the number of dummy WUs are greater than the number of real WUs, the remaining/excess dummy WUs can remain in the content or be replaced by NULL or redundant data. After the content image is built by the Image Builder module 315, the content is physically formatted by the Physical Formatting Module 320. The physically formatted content is then mastered by the Mastering Module 325.

In another embodiment of the present invention, AACS (Advanced Access Content System) files are inserted during the replication stage. AACS defines an advanced, robust and renewable method for protecting entertainment content including high-definition audio-visual content. In a typical workflow, the encoded content is prepared and formatted as CMF files during authoring, and then such CMF files are transferred to replicator for making discs. However, various AACS keys and other files are only obtained by a disc replicator from an AACS Licensing Agency after receiving CMF files from an authoring phase. Thus, using the method of the present invention dummy data are created and added during UDF formatting and carried in the CMF files during authoring. At the replication stage, the dummy data are replaced by these AACS keys and files.

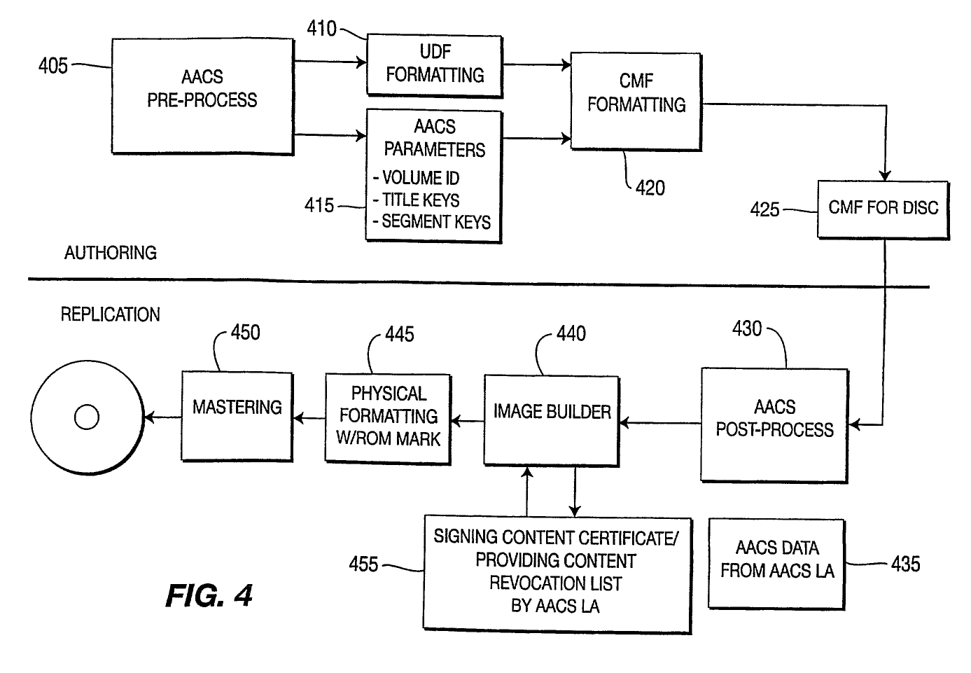

FIG. 4 illustrates the method of the present invention whereby the AACS files are applied to an optical disc. The AACS PreProcess module 405 of the authoring stage creates dummy AACS data. The dummy AACS data are included in the UDF formatted files and/or CMF formatted files. The content is UDF formatted by a UDF Formating module 410. The AACS parameters are generated by the AACS Parameter module 415. Together the UDF formatted files and the AACS parameters are input to the CMF Formatting module 420, which generates CMF formatted files. The CMF formatted files are transferred to a replicator by a CMF for Disc module 425 to make discs in the replication phase/stage.

In the replication stage, these dummy AACS data are replaced by real AACS keys and files received from AACS LA (Licensing Agency). Specifically, the AACS PostProcess module 430 accepts real AACS keys and files from an AACS Licensing agency via the AACS Data from AACS LA module 435. The AACS PostProcess module 430 locates the previously inserted dummy values and replaces the dummy values with the real AACS keys and files. The AACS Post Process module 430 provides input to the Image Builder module 440. The Image Builder module 440 also accepts input from the Signing Content Certificate/Providing Revocation List by AACS LA module 455, which allows the Image Builder module to sign the content certificate. After the content image is built by the Image Builder module 440, the content is physically formatted by the Physical Formatting Module 445. The physically formatted content is then mastered by the Mastering Module 450.

It is to be understood that the present invention may be applied to any system in a content production/distribution workflow where dummy “placeholders” are first created and inserted into an encoded content, and then these placeholders are replaced or filled with real value at a later stage of the workflow.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method for processing content, said method comprising:
generating a dummy value;
inserting said dummy value into encoded content in a content preparation phase;
selecting a position in said encoded content where said dummy value in said encoded content is to be replaced by a real value;
generating said real value; and
replacing said dummy value with said real value in said encoded content.

2. The method according to claim 1, wherein said encoded content is a motion picture experts group formatted transport stream.

3. The method according to claim 2, wherein said dummy value is inserted into said motion picture experts group transport stream by multiplexing said dummy values with said motion picture experts group transport stream.

4. The method according to claim 1, wherein said dummy value is inserted into universal disk format files.

5. The method according to claim 1, wherein said dummy value is inserted into cutting master format files.

6. The method according to claim 1, wherein said real value is an alternative value containing watermark signals.

7. The method according to claim 1, wherein said real value is an advanced access content system (AACS) key and related data.

8. The method according to claim 1, wherein any excess dummy values in said encoded content after inserting said real value is replaced by a null value.

9. The method according to claim 1, wherein any excess dummy values in said encoded content after inserting said real value is replaced by a redundant value.

10. The method according to claim 1, wherein any excess dummy values in said encoded content after inserting said real value remain in said encoded content.

11. The method according to claim 1, wherein said first generating step and said inserting step are performed during content authoring.

12. The method according to claim 1, wherein said selecting step, said second generating step and said replacing step are performed during content replication.

13. The method according to claim 1, further comprising:
building a content image; and
mastering said content image for replication of said content image onto a storage medium.

14. A system for processing content, comprising:
means for generating a dummy value;
means for inserting said dummy value into encoded content in a content preparation phase;
means for selecting a position in said encoded content where said dummy value in said encoded content is to be replaced by a real value;
means for generating said real value; and
means for replacing said dummy value with said real value in said encoded content.

15. The system according to claim 14, wherein said encoded content is a motion picture experts group formatted transport stream.

16. The system according to claim 15, wherein said dummy value is inserted into said motion picture experts group transport stream by multiplexing said dummy values with said motion picture experts group transport stream.

17. The system according to claim 14, wherein said dummy value is inserted into universal disk format files.

18. The system according to claim 14, wherein said dummy value is inserted into cutting master format files.

19. The system according to claim 14, wherein said real value is an alternative value containing watermark signals;

20. The system according to claim 14, wherein said real value is an advanced access content system (AACS) key and related data.

21. The system according to claim 14, wherein any excess dummy values in said encoded content after inserting said real value is replaced by a null value.

22. The system according to claim 14, wherein any excess dummy value in said encoded content after inserting said real value is replaced by a redundant value.

23. The system according to claim 14, wherein any excess dummy value in said encoded content after inserting said real value remain in said encoded content.

24. The system according to claim 14, wherein said first means for generating and said means for inserting are performed during content authoring.

25. The system according to claim 14, wherein said means for selecting, said second means for generating and said means for replacing are performed during content replication.

26. The system according to claim 14, further comprising:
means for building a content image; and
means for mastering said content image for replication of said content image onto a storage medium.
